(19) United States
(12) Patent Application Publication
(10) Pub. No.: US 2005/0226963 A1
(43) Pub. Date: Oct. 13, 2005

(54) Character-shaped snack food containing hardening agent

(76) Inventors: Donald R. Addington, Bluffton, IN (US); Eric Kufel, Phoenix, AZ (US); Glen E. Flook, Scottsdale, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/822,039

(22) Filed: Apr. 8, 2004

(51) Int. Cl. A23L 1/28

(52) U.S. Cl. 426/104

(57) ABSTRACT

A snack food product contains potato product and corn product. The potato product provides flavor and the corn product acts as a hardening agent to add rigidity, stiffness, and structural integrity to reduce product breakage during packaging, shipping, and handling. The potato and corn ingredients mixed with other ingredients to provide a dough mixture. The dual-sheeted dough is cut into character-shaped forms. An air-assisted cylindrical cutter with air holes within the character cut-outs is used to at least partially detach the character-shaped forms from the web scrap. A frictional surface removes any remaining dangling snack food forms from the web scrap. The character-shaped forms routed to a fryer to cook the snack food product. The snack food product is rotated while cooking in the fryer with jet streams of cooking oil from nozzles about the fryer bath. The snack food product is inspected and package for shipment.

### CROSS REFERENCE TO RELATED PATENT APPLICATION(S)

The present patent application is related to copending U.S. patent application Ser. No. (Pending), Attorney Docket No. 133006.00006, entitled “System and Method of Manufacturing Character-Shaped Snack Food Product”, filed concurrently herewith by Donald R. Addington et al. The present patent application is further related to copending U.S. patent application Ser. No. (Pending), Attorney Docket No. 133006.00007, entitled “Apparatus and Method of Separating Character Forms from Sheeted Dough while Manufacturing Snack Food Product”, filed concurrently herewith by Donald R. Addington et al.

### FIELD OF THE INVENTION

The present invention relates in general to snack food products and, more particularly, to a character-shaped snack food containing a hardening agent to provide stiffness to the outer shell.

### BACKGROUND OF THE INVENTION

Snack food products are well established and an integral part of the eating habits and food choices made by many people. Kids enjoy snack foods as a treat and means of social interaction with their peers. Adults eat snack foods when watching sporting events and television and to fulfill that late night food craving. Snack food taste good and provide a way of treating ourselves. In combination with a well balanced diet, snack foods are an integral part of most healthy diets and relatively harmless when taken in reasonable quantities.

Snack foods come in a wide variety of shapes, sizes, flavors, textures, and themes. One of the more common snack foods of choice is the cracker-type product. Most cracker products begin with enriched flour, sugar, and cottonseed oil as ingredients, which are used to make a dough. The dough is run through a roller to make a single sheet. The sheet is cut into forms of the cracker shape. For example, the cracker may have square, circular, oval, and other two-dimensional shapes. The cracker is a solid body, without much in the way of detail, patterns, or appendages in its structure. The cut-out dough is baked or fried to cook the dough, which produces a crunchy texture or structure of the cracker. Seasoning is then added for additional flavor. The cracker product may be visually inspected before sealing in plastic or aluminum foil package for shipping and commercial sale.

A common problem with snack food products is the breakage factor. A package may contain a large number of crackers. Even through the package is sealed, the crackers within the package still rub and press against one another during shipment, handling, and storage. The packages are squeezed and packed tightly together which can cause additional crackers to break into pieces. Moreover, the weight of the crackers in the top of package as transferred to the crackers in the bottom on the package, and the weight of one package on another package, results in further breakage. One of the criteria used by end customers to evaluate the quality of a product is its wholeness or lack of breakage at the time of consumption or usage. Customers prefer to find whole, intact crackers when they open the package and partake of its contents.

Another problem encountered in the manufacture of snack food products involves the separation of the snack food forms from the sheeted dough following the cutting operation. Unless the cut is clean around the entire perimeter of the snack food form, the cut-out form may remain partially connected to the sheeted dough, also known as clinging or dangling forms. The snack food forms that do not completely separate from the sheeted dough are sent back to the beginning of the processing line as part of the web scrap. The dangling forms reduce production yield and increase per unit costs.

Yet another consideration in the manufacture of snack food products involves the cooking of the snack food forms in the fryer. The snack food forms tend to float on the surface of the cooking oil. One side of the snack food is submerged in the cooking oil and the other side floats above the surface of the cooking oil and as such is exposed to the air. The submerged portion of the snack food receives a higher cooking temperature and therefore cooks more in a given time than the side that is exposed to air. If the snack food spends its entire time in the fryer with one side submerged and the other side exposed to air, then the snack food will cook unevenly. The two sides of the snack food will have different textures, coloration, and degrees of crunchiness. It is preferable to cook the snack food evenly in the fryer.

### SUMMARY OF THE INVENTION

In one embodiment, the present invention is a method of making a snack food product comprising the steps of mixing potato product and corn product to form a dough, rolling the dough into a dual-sheeted dough, cutting the dual-sheeted dough into character-shaped forms having a main body portion and a plurality of appendages extending from the main body portion, wherein the appendages have smaller dimensions than the main body portion, and frying the character-shaped forms to produce the snack food product having an outer shell and a hollow interior. The corn product increases the hardness of the outer shell of the character-shaped form to reduce breakage of the appendages during handling and storage.

In another embodiment, the present invention is a snack food product made by a process comprising the steps of forming a dough mixture including a hardening agent, rolling the dough mixture into a sheeted dough, cutting the sheeted dough into forms having a main portion and an extension extending from the main portion, wherein the extension has smaller dimensions than the main portion, and frying the forms to produce the snack food product having an outer shell. The hardening agent increases stiffness of the outer shell of the form to reduce breakage of the extension.

In yet another embodiment, the present invention is a snack food product comprising a form having an outer shell made from a dough mixture comprising a hardening agent. The form has a main portion and an extension from the main portion. The extension has smaller dimensions than the main portion. The hardening agent provides stiffness to the outer shell to reduce breakage of the extension.

### BRIEF DESCRIPTION OF THE DRAWINGS

FIG. 1 is a block diagram of a snack food product manufacturing process line;

FIG. 2 illustrates a computer system for controlling the snack food processing line;

FIG. 3 illustrates further detail of the roller assembly;

FIG. 4 illustrates further detail of the air-assisted cutter assembly;

FIG. 5 illustrates one row of character cut-outs on the cutter assembly;

FIGS. 6a-6c illustrate various embodiments of the character-shaped snack food product;

FIG. 7 illustrates the character cut-outs being separated from the dual-sheeted dough; and

FIG. 8 illustrates further detail of the fryer with jet streams to rotate the character forms.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

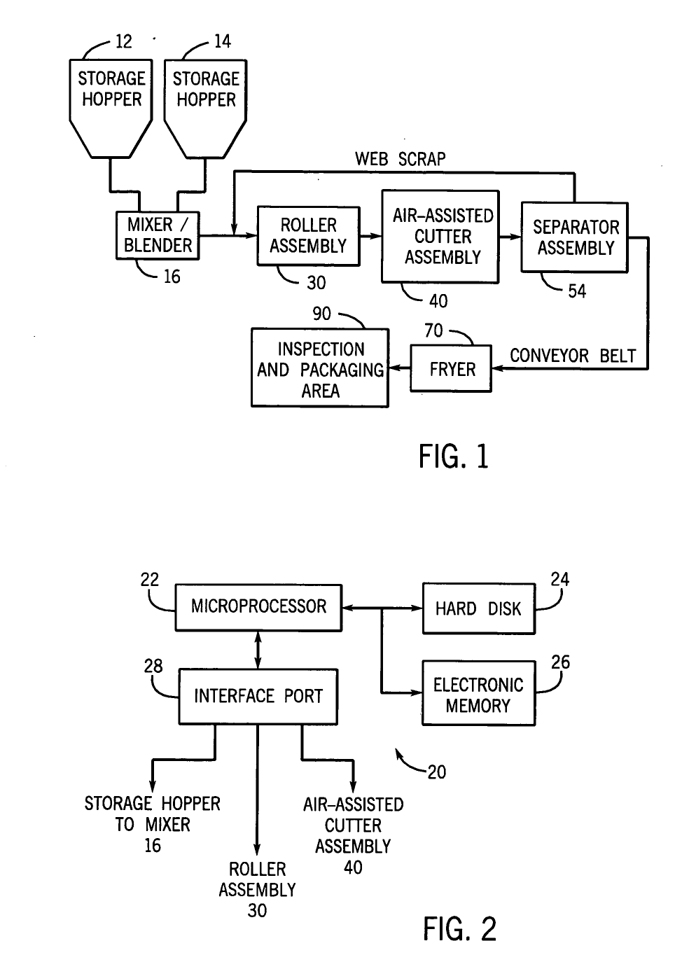

Referring to FIG. 1, a block diagram representing manufacturing process line 10 is shown suitable for producing a snack food product. The ingredients for the snack food product, including potato and corn, are blended together into a mixture, which is then rolled into a dual-sheeted dough. The dual-sheeted dough is cut in the form of characters. The characters can be fictional, cartoon, animated, and real-life images. Examples of the characters include rabbits, birds, Tasmanian devils, dogs, and other popular and readily recognizable caricatures, figurines, and images. The characters are made with a high level of definition and detail which makes them more recognizable and enjoyable. The character-shaped forms are fried to create a three-dimensional snack food product having a relatively solid yet crunchy outer shell and hollow or substantially air-filled interior. The characters are packaged for shipping and consumer sale.

The manufacturing process begins with potato flakes, corn flour, vegetable oil, potato starch, salt, and mono-& diglycerides as ingredients to make the snack food product. In a high volume manufacturing facility, the ingredients arrive from suppliers in large quantities and are stored in a cool, dry location. The ingredients may arrive in sacks, barrels, boxes, or bulk in sanitized trucks. The ingredients are placed in clean storage hoppers 12 and 14 and fed by conduit into mixer 16. Each storage hopper contains a separate ingredient. Storage hopper 12 contains potato flakes and storage hopper 14 contains corn flour. The routing of the ingredients and feed rate into mixer 16 is precisely controlled by computer system 20 as shown in FIG. 2.

Computer system 20 is used to control electronic and mechanical processes in manufacturing line 10. Computer system 20 is a general purpose computer including a central processing unit or microprocessor 22, mass storage device or hard disk 24, electronic memory 26, and interface port 28. Interface port 28 sends electrical signals to control the equipment and components of manufacturing process line 10.

In the present discussion, computer 20 runs application software operating in electronic memory 26, which controls the operation of the equipment and components of manufacturing process line 10. The recipe for the snack food product and manufacturing control parameters are stored on hard disk 24 and accessed by the application software. Computer 20 accesses the recipe from hard disk 24 and controls manufacturing line 10 to produce the desired quantity of snack food product. For example, storage hoppers 12 and 14 have electrical controlled actuator valves that open the conduit to dispense the ingredients into mixer 16. The conduit from storage hoppers 12 and 14 to mixer 16 may include an air pressure assist feature, also controlled by computer 20, to move the ingredients down the line at a known rate and reduce plugging or clogging.

When mixing a new batch of snack food product, computer 20 activates a valve for the potato flake hopper 12 for the appropriate amount of time to dispense the correct proportion of potato flakes into mixer 16. Likewise, computer 20 activates a valve for the corn flour hopper 14 for the appropriate amount of time to dispense the correct proportion of corn flour into mixer 16. Computer 20 sends the control signals to close the actuator valves for storage hoppers 12 and 14. The other ingredients noted above are dispensed from their hoppers and added to the mixture in the appropriate measure and timing. The ingredients are blended together with water at high speed in mixer 16 to produce a mixture or dough.

The dough mixture from mixer 16 is fed into roller assembly 30 to produce a sheet of dough approximately 54 inches wide and 0.125 inches thick. Roller assembly 30 includes two metal cylinders each about 48 to 60 inches long and 20 inches in diameter. The cylinders rotate in opposite relative directions in proximity to one another to produce the thin-sheeted dough.

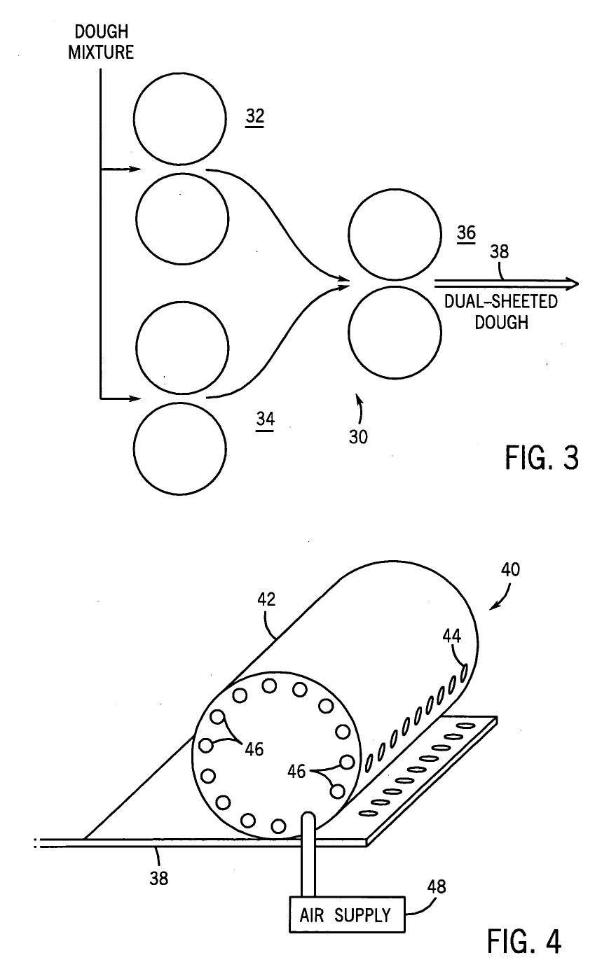

In one embodiment, the roller assembly, as described in U.S. Pat. No. 5,268,187, which is incorporated herein by reference, produces two sheets of dough. In another embodiment, as shown in FIG. 3, a first set of rollers 32 are positioned above a second set of rollers 34. Rollers 32 work in concert with rollers 34 produce two individual sheets of dough. The two individual sheets of dough come off rollers 32 and 34 at the same rate of speed. The two sheets of dough are routed through a third set of rollers 36 where they are laminated or joined together to form a double or dual-sheeted dough 38. A detailed inspection would show the two laminated sheets of dough lightly touching in some locations and being separated by a narrow air gap in other locations.

Roller assembly 30 uses 20-inch diameter rollers to keep the dough a more uniform thickness across the width of the sheet. The wider roller also provides more snack food products to fry per hour, which results in increased production output and lower per unit cost. However, the dual-sheeted dough 38 is more difficult to compress and evenly spread-out. A smaller diameter roller may deflect from the pressure exerted by dual-sheeted dough 38, in and around the middle portion of the roller during the rolling operation, and create a non-uniform thickness of the dough. The wider roller reduces deflection across the roller and produces uniform thickness across the sheeted dough.

The double-sheeted dough is routed to air-assisted cutter assembly 40 to cut out individual shapes and forms of the snack food product, see FIG. 1. Further detail of cutter assembly 40 is shown in FIG. 4. Cutter assembly 40 is cylindrical with multiple rows of character cut-outs. Cylinder 42 is made of bronze overlaid with plastic. While only one row of character cut-outs 44 is shown, the rows of character cut-outs substantially cover the entire surface of cylinder 42. Cylinder 42 rotates as dual-sheeted dough 38 passes underneath. The character cut-outs penetrate or are imbedded into dual-sheeted dough 38 as it passes underneath the cutter, which cuts the dough in the form of the character shape.

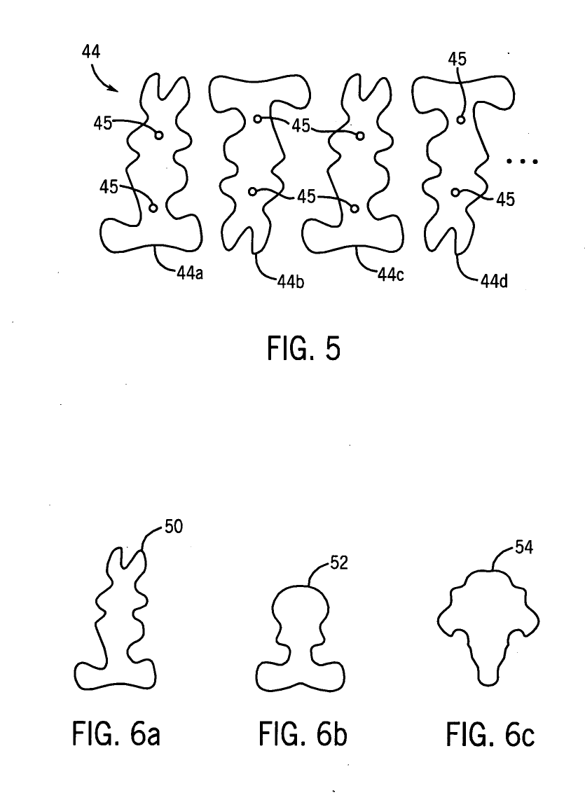

Depending on the character shapes, the character cut-outs in the surface of cylinder 42 may be positioned in alternating orientation. For example, within one row, rabbit cut-outs 44 are positioned with adjacent characters head to toe. Rabbit cut-out 44a is oriented head up, and rabbit cut-out 44b in the same row is oriented head down, and rabbit cut-out 44c in the same row is orient head up, and so on, as shown in FIG. 5.

The alternating orientation maximizes the character cut-outs in one row and the number of character forms cut per unit area of dough. The areas between the character forms cut in the dual-sheeted dough is scrap material, commonly referred to as web scrap. The web scrap is typically routed back to be re-introduced into manufacturing process line 10 with the dough mixture prior to the roller assembly 30. It is generally desirable to reduce the amount of web scrap. More characters forms cut in the dough per unit area means higher production, lower costs, and less web scrap.

Cutter assembly 40 operates under control of computer 20. Computer 20 sends electronic control signals to cutter assembly 40 via interface port 28 to control the rotational speed, position, and cutting pressure of the cylinder cut-outs against the dual-sheeted dough. Since the dual-sheeted dough passes underneath cylinder 42, the cutter performs its cutting operation at the bottom of the cylinder rotation. Cutter assembly 40 is an air-assisted cutter in that it relies on air pressure to assist in the removal of the snack food forms from the web scrap following the cutting operation. Cutter assembly 40 includes pneumatic actuators that force air pressure to holes 45 within each character cut-out. FIG. 5 illustrates a portion of one row of character cut-outs on the surface of cylinder 42. Each character cut-out typically has one or two holes 45 depending on the detail of the form. Sometimes one air hole is sufficient to dislodge the character form from the web scrap. Other times, two holes, one at each end of the character cut-out, are used to remove or peel off the character form from the web scrap. In yet other embodiments, three or more holes are needed to reliably detach or peel off the character form from the web scrap.

An air conduit or manifold 46 runs under each row of character cut-outs 44, as shown in FIG. 4. As cylinder 42 spins, the rows of character cut-outs makes cuts in the dough. As each row of character cut-outs finish its cut and begins to rotate upward, air conduit 46 aligns with air supply 48. Computer 20 sends a control signal to cause air supply 48 to release a blast of air into air conduit 46 and out holes 45 under each character cut-out within that row. The character forms, having just been cut at the bottom of the cylinder rotation, are at least partially blown away from the dual-sheeted dough.

The holes 45 in the character cut-out are known to become plugged with dough from time to time. At regular intervals, computer 20 sends a control signal to cause air supply 48 to release a super blast of air to clean out holes 45.

By its nature, cutter assembly 40 cuts the dough into two-dimensional cut-out forms, i.e., they have length and width. The inherent quality of dual-sheeted dough to rise and form an air pocket between the dual sheets of dough during frying introduces a third dimension of depth or thickness to the snack food product. Although the discernable features are found in the two-dimensional aspect, i.e., its length and width as perceived from the front and back of the product, the end snack food product is considered 3-dimensional in form. The frying process causes the snack food product to expand and creates an internal hollow portion or air pocket surround by the hard shell.

In the present discussion, the snack food forms are cut in the shape of cartoon characters. The cartoon characters have fine detail in their form. For example, the animated character may be shaped as rabbit 50, which stands upright with tall ears, wide face and torso, and big feet as shown in FIG. 6a. Another animated character can be small bird 52 with a disproportionately large head, small body, and large feet, as shown in FIG. 6b. Yet another character can be a mischievous Tasmanian devil 54 in a state of action, i.e., whirlwind around its body, as shown in FIG. 6c.

The snack food product can take the form of many other shapes, objects, and images. For example, the snack food form may be shaped as a live animal, fish, whale, dolphin, bird, dog, tree, plant, natural or geographic formation, vehicle, watercraft, aircraft, building, dwelling, monument, structure, alphanumeric symbols, fictional character, sports personality, heroes, famous persons, and other real images (living or deceased), each with associated fine detail. The snack food form has a main body portion and a plurality of appendages or extensions defining the fine detail. The detail may include fins, tails, wings, arms, legs, feet, ears, heads, appendages, branches, leaves, wheels, windows, tools, clothing, circulating debris, and other features which extends from the main body with small connection points that are vulnerable to breakage. The appendages or extends have smaller dimensions than the main body.

While the shape or theme of the character can take many forms, poses, and states of activity, one aspect of the snack food product is the intricate and minute detail in the figure. The tall ears of the rabbit character, and the large feet of the bird character, and the body details of the devil character in a whirlwind state, all necessitate fine detail in the form and strength in the narrow-connection of the appendages to the main body. In general, the detailed appendages or extensions have dimensions smaller than the main body portion, e.g., the rabbit's ears are smaller than its torso and have small connections to the main body. The narrowly-connected appendages are vulnerable to breakage during storage and handling. Nonetheless, when the end consumer opens the package containing the snack food product, the expectation is for most, if not all, or at least the vast majority, of the characters to be whole and intact, including the appendages and other fine details of the characters.

Accordingly, it is desirable to reduce the breakage factor noted in the background. The quality of the snack food product in the mind of the end consumer would suffer if the ears of the rabbit character are partially or completely broken off, or if one or both feet of the bird character are missing, or if the whirlwind around the devil character is not fully intact. In fact, one of the selling features of the character-shaped snack food product is the ability and interest of the children in playing with the characters, much like any other toy, before consuming the product. It is a novelty for kids to have the option of eating their toys, and parents receive the benefit of not having to pick up the toys after playtime—because they have been eaten.

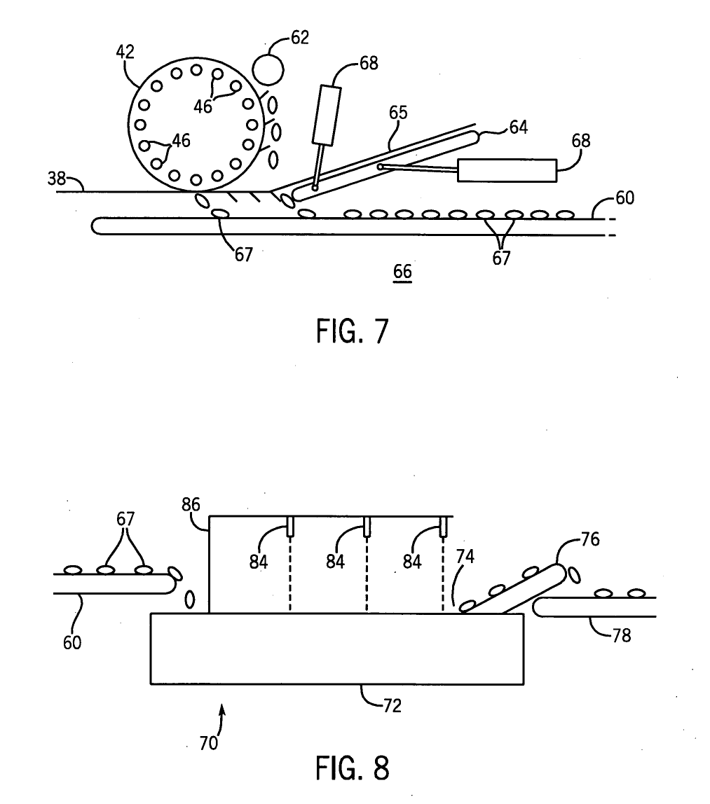

When the dual-sheeted dough is run across cutter assembly 40, one result is that the snack food forms are cut cleanly from the dual-sheeted dough and fall onto conveyor belt 60 as shown in FIG. 7. Conveyor belt 60 is positioned under cutter assembly 40 to catch the loose snack food forms. Another possible result of the cutting operation is that the snack food forms are cut cleanly from the dual-sheeted dough but remain stuck to the surface of cylinder 42. For this case, brush 62 is positioned in proximity to cylinder 42. Brush 62 rotates using a chain-drive and brushes any snack food forms clinging to the surface of cylinder 42. The snack food forms again fall onto web scrap 65 where they can be detached by separator 64, or become part of the web scrap for reprocessing.

The final possibility is that the snack food forms are not completely cut away from the web scrap. If cutter assembly 40 fails to cleanly cut the entire perimeter of the snack food form, i.e., one or more points remain attached to the web scrap, then the product is left clinging to, or dangling from, or partially attached to the web scrap as it exits the cutting area. It is desirable to completely detach as many dangling snack food forms as possible in order to maximize the product reaching conveyor belt 60.

Accordingly, a separator or frictional surface 64 is positioned in proximity to the exit point where the web scrap leaves cutter assembly 40. The web scrap 65 with dangling snack food forms 67 is routed toward the edge of separator 64. Web scrap 65 is angled so that it travels along the upper surface of separator 64. The dangling snack food forms 67 come in contact with the edge of separator 64 where they are knocked off or detached from web scrap 65 and fall onto conveyor belt 60. After leaving separator 64, web scrap 65 is returned to be re-introduced into manufacturing process line 10, as part of the dough mixture prior to roller assembly 30.

Separator 64 is supported by a horizontal surface 66, which further supports conveyor belt 60. Separator 64 includes adjustable pneumatic pistons 68 positioned on one or both sides of separator 64, and operating under control of computer 20 by way of interface port 28, to select the horizontal distance between cutter assembly 40 and the edge of frictional surface 64, and further to select the angle of separator 64 with respect to horizontal surface 66. The distance between cutter assembly 40 and the edge of frictional surface 64 may be set to 6 inches and the operating angle of separator 64 to 30-40 degrees for maximum effectiveness in separating the dangling snack food forms 67 from web scrap 65. Again, the system operating parameters are set so that the maximum number of snack food forms 67 fall onto conveyor belt 60 and are routed to fryer 70, see FIG. 1. Conveyor belt 60 is the transport mechanism to route snack food forms 67 to fryer 70.

Further detail of fryer 70 is shown in FIG. 8. Fryer 70 includes bath 72 containing cooking oil, e.g., vegetable oil or coconut oil. The cooking oil is maintained at a temperature of about 280 degrees Fahrenheit. Fryer bath 72 is about 60 inches wide, 20 feet long, and ranges in depth from 0.5 inches under conveyor belt 60 to 5.0 inches in the middle. Conveyor belt 60 terminates over fryer bath 72. As the snack food forms leave conveyor belt 60, character-shaped dough cut-outs fall into fryer bath 72. The cooking oil continuously circulates from so that the snack food forms move toward exit point 74 of fryer bath 72. The speed of movement of the snack food forms is set so that the cooking process is complete by the time the snack food product reaches exit point 74. The snack food product is cooked to a crunchy consistency or texture with a hard outer shell and partially hollow interior. A conveyer belt 76 removes the snack food product from fryer bath 72. Conveyor belt 76 is an open metal mesh to allow excess cooking oil to drip back into fryer bath 72. Conveyor belt 76 may have a vibration to aid in removing excess cooking oil from the snack food product. The snack food product is transferred to conveyor belt 78 where it is routed to a station to add seasoning for flavor. The snack food product continues along to inspection and packaging area 90, see FIG. 1.

While cooking in fryer bath 72, the snack food product has a natural tendency to float on the surface of the cooking oil. As such, a first side of the snack food product is below the surface of the cooking oil and a second side of the snack food product is above the surface of the cooking oil. The portion of the snack food product that is submerged in the cooking oil is exposed to a higher temperature, i.e., that of the cooking oil, than the portion of the product above the surface of the cooking oil, which is exposed to the temperature of the surrounding air.

In order to provide an even cooking process, the snack food product is flipped or rotated during its time in fryer bath 72. By flipping the snack food product, that portion that had been below the surface of the cooking oil is made to be above the surface and that portion that had been above the surface of the cooking oil is made to be below the surface. The snack food product should be flipped or rotated multiple times during the cooking process for more consistent results.

Accordingly, nozzles 84 are positioned above fryer bath 72 as shown in FIG. 8. Nozzles 84 are directed vertically down into fryer bath 72. Cooking oil is pumped from fryer bath 72 and routed through conduit or tubing 86 to nozzles 84. Nozzles 84 direct a stream or jet of cooking oil toward fryer bath 72, striking the surface of the cooking oil and the snack food product floating thereon. The pressure and force from the jet stream of cooking oil from nozzles 84 cause the snack food product to momentarily submerge, turn or rotate to a new position, thereby re-orienting the snack food product so that the portion which had been above the surface is now submerged in the cooking oil and visa versa. Three sets of nozzles 84 are positioned at regular intervals along the length of fryer bath 72, causing the snack food product to rotate at least three times during the cooking process. There are sufficient nozzles 84 in each set positioned across the width of fryer bath 72 to rotate substantially all the snack food product in the line of the jet streams.

In another embodiment, nozzles 84 are angled with respect to the surface of the cooking oil. The jet stream is still sufficient pressure and force to submerge, turn or rotate the snack food product and thereby evenly expose all surfaces to the cooking oil.

Once the snack food product leaves fryer 70 by way of conveyor belt 78 it is routed to a station where seasoning is added for additional flavor. The snack food product continues along to inspection and package area 90. A quantity of character snack food product is measured by weight or by volume and deposited into package. The package is sealed and boxed for shipment.

The boxes undergo the normal pressures, stress, and contact associated with handling and shipment. The boxes of snack food product are stacked several layers high, moved by forklift, hauled by truck, stored in warehouses, and ultimately arrive at retail outlets where the boxes are unpacked and packages are handled while stocking the product on store shelves. Again, the end customer expects the vast majority of characters to be whole and intact, and will measure, evaluate, and assess the quality of the product accordingly.

One aspect of the snack food product described herein, that aids and contributes to reducing product breakage, is the use of a hardening agent such as corn flour or corn granules as an ingredient to the dough. The corn flour or granules adds hardness, stiffness, rigidity, and structural integrity to the end product. Grain products such as rice flour and wheat flour can also be used in combination with or in lieu of the corn flour as the hardening agent to achieve the desired product hardness and stiffness quality. The fine detail and features of the snack food product remain whole and intact even in the view of the narrowly-connected structures and rough handling.

Another useful ingredient is potato product such as potato flakes, which add flavor, carbohydrates, starch, and other nutrients to the snack food product. Potato flakes cost more per unit volume than corn flour. Consequently, a combination of potato flakes and corn flour offers the advantages of flavor and nutritional content with lower cost and hardness and stiffness that results in less product breakage. The customers get the flavor, crunchiness, and whole product shape, i.e., low level of breakage, they are expecting.

1. A method of making a snack food product, comprising:
mixing potato product and corn product to form a dough;
rolling the dough into a dual-sheeted dough;
cutting the dual-sheeted dough into character-shaped forms having a main body portion and a plurality of appendages extending from the main body portion, wherein the appendages have smaller dimensions than the main body portion; and
frying the character-shaped forms to produce the snack food product having an outer shell and a hollow interior, wherein the corn product increases hardness of the outer shell of the character-shaped form to reduce breakage of the appendages during handling and storage.

2. The method of claim 1, wherein the potato product is potato flake.

3. The method of claim 1, wherein the corn product is corn flour.

4. The method of claim 1, further including the steps of:
storing the potato product in a first hopper;
storing the corn product in a second hopper;
dispensing the potato product from the first hopper into a mixer;
dispensing the corn product from the second hopper into the mixer; and
blending the potato product and the corn product to form the dough.

5. The method of claim 1, wherein the character-shaped form is a rabbit, bird, dog, or devil.

6. The method of claim 1, wherein the appendage is a leg, foot, arm, or ear.

7. A method of making a snack food product, comprising:
forming a dough mixture including a hardening agent;
rolling the dough mixture into a sheeted dough;
cutting the sheeted dough into forms having a main portion and an extension extending from the main portion, wherein the extension has smaller dimensions than the main portion; and
frying the forms to produce the snack food product having an outer shell, wherein the hardening agent increases stiffness of the outer shell of the form to reduce breakage of the extension.

8. The method of claim 7, wherein the step of rolling the dough mixture includes the steps of:
forming a first sheet of dough from the dough mixture;
forming a second sheet of dough from the dough mixture; and
combining the first and second sheets of dough to provide a dual-sheeted dough.

9. The method of claim 7, wherein the hardening agent is selected from the group consisting of corn flour, rice flour, and wheat flour.

10. The method of claim 7, further including the steps of:
storing the hardening agent in a hopper;
dispensing the hardening agent from the hopper into a mixer; and
blending the hardening agent with other ingredients to form the dough mixture.

11. The method of claim 7, wherein the form is a rabbit, bird, dog, or devil.

12. The method of claim 7, wherein the extension is a leg, foot, arm, or ear.

13. A snack food product made by a process comprising the steps of:
forming a dough mixture including a hardening agent;
rolling the dough mixture into a sheeted dough;
cutting the sheeted dough into forms having a main portion and an extension extending from the main portion, wherein the extension has smaller dimensions than the main portion; and
frying the forms to produce the snack food product having an outer shell, wherein the hardening agent increases stiffness of the outer shell of the form to reduce breakage of the extension.

14. The snack food product of claim 13, wherein the step of rolling the dough mixture includes the steps of:
forming a first sheet of dough from the dough mixture;
forming a second sheet of dough from the dough mixture; and
combining the first and second sheets of dough to provide a dual-sheeted dough.

15. The snack food product of claim 13, wherein the hardening agent product is selected from the group consisting of corn flour, rice flour, and wheat flour.

16. The snack food product of claim 13, further including the steps of:
storing the hardening agent in a hopper;
dispensing the hardening agent from the hopper into a mixer; and
blending the hardening agent with other ingredients to form the dough mixture.

17. The snack food product of claim 13, wherein the form is a rabbit, bird, dog, or devil.

18. The snack food product of claim 17, wherein the extension is a leg, foot, arm, or ear.

19. A snack food product, comprising a character-shaped form having an outer shell made from a mixture comprising potato product and corn product, the character-shaped form having a main body portion and a plurality of appendages extending from the main body portion, the appendages having smaller dimensions than the main body portion, wherein the corn product provides hardness to the character-shaped form to reduce breakage of the appendages during handling and storage.

20. The snack food product of claim 19, wherein the corn product is corn flour.

21. The snack food product of claim 19, wherein the form is a rabbit, bird, dog, or devil.

22. The snack food product of claim 21, wherein the extension is a leg, foot, arm, or ear.

23. A snack food product, comprising a form having an outer shell made from a dough mixture comprising a hardening agent, the form having a main portion and an extension from the main portion, the extension having smaller dimensions than the main portion, wherein the hardening agent provides stiffness to the outer shell to reduce breakage of the extension.

24. The snack food product of claim 23, wherein the hardening agent is selected from the group consisting of corn flour, rice flour, and wheat flour.

25. The snack food product of claim 23, wherein the form is a rabbit, bird, dog, or devil.

26. The snack food product of claim 25, wherein the extension is a leg, foot, arm, or ear.
